(19) United States
(12) Patent Application Publication
(10) Pub. No.: US 2008/0182029 A1
(43) Pub. Date: Jul. 31, 2008

(54) Method for manufacturing hard coat film

(75) Inventor: Takeshi Nishikawa, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/005,868

(22) Filed: Dec. 28, 2007

(30) Foreign Application Priority Data
Jan. 30, 2007 (JP) 2007-019035

(51) Int. Cl. C08F 2/46

(52) U.S. Cl. 427/508

(57) ABSTRACT

One embodiment of the present invention is a method for manufacturing a hard coat film having a cellulose ester substrate and a hard coat layer on the cellulose ester substrate, comprising: applying a coating material, an ionizing radiation-curable material being dissolved or dispersed in the material; drying the coating material applied to the cellulose ester substrate; forming a hard coat layer by curing the coating material by irradiating the coating material with an ionizing radiation; and baking the cellulose ester substrate having the hard coat layer.

### CROSS REFERENCE

This application claims priority to Japanese application number 2007-019035, filed on Jan. 30, 2007, which is incorporated by reference.

### BACKGROUND OF THE INVENTION

1. Field of the Invention

This invention relates to a hard coat film to be provided on a surface of a window, a display, and the like. Particularly, this invention relates to the hard coat film to be provided on a surface of a display such as a liquid crystal display (LCD), a CRT display, an organic electroluminescence display (ELD), a plasma display (PDP), a surface-conduction electron-emitter display (SED), and a field emission display (FED).

2. Description of the Related Art

A functional layer is provided in or on a protective film for a polarizing plate for a liquid crystal display (LCD), a protective film for a circularly polarizing plate for an organic electroluminescence display (ELD) or the like in order to provide them with various functions. Examples of the functional layers are an antistatic layer for providing them with an antistatic function, a reflection preventing layer for reducing reflection and a hard coat layer for improving a surface hardness. Especially, the hard coat layer has become a necessary element for a display. The embodiment of the hard coat layer is a single layer or a lower layer of the reflection preventing layer. The hard coat layer has become an important technology.

A hard coat layer provided on a cellulose film substrate is formed by the following processes: a coating material including an organic solvent is applied to the substrate; the coating material is dried; thereafter the coating material is cured by being irradiated with an ultra violet ray. In recent years, a hard coat film having a hard coat layer for protecting a polarizing plate is required to be highly hardened. A cellulose ester type film is used for a hard coat film substrate used for a protective film of a polarizing plate. However, the cellulose ester type film is soft, and it is difficult to harden the cellulose ester type film.

[patent document 1] JP-A-2006-182865

### SUMMARY OF THE INVENTION

The present invention is to provide a method for manufacturing a hard coat film with a highly hardened hard coat layer using a cellulose ester substrate. One embodiment of the present invention is a method for manufacturing a hard coat film having a hard coat layer on a cellulose ester substrate. This embodiment includes a step of applying a coating material in which an ionizing radiation-curable material is dissolved or dispersed in a solvent to the cellulose ester substrate, a step of drying the coating material applied to the cellulose ester substrate, a step of curing the coating material to form a hard coat layer by irradiating the coating material with ionizing radiation and a step of baking the cellulose ester substrate with the hard coat layer.

### BRIEF DESCRIPTION OF THE DRAWINGS

FIG. 1 is an exemplary cross-sectional diagram of one embodiment of a hard coat film of the present invention.

FIG. 2 is an exemplary cross-sectional diagram of another embodiment of a hard coat film of the present invention.

FIG. 3 is an exemplary cross-sectional diagram of a transmission type liquid crystal display having a hard coat film of the present invention on a surface of the display.

In these drawings, 1 is a hard coat film; 11 is a cellulose ester substrate (a substrate); 12 is a hard coat layer; 13 is a low refractive index layer (a reflection preventing layer); 2 is a polarizing plate; 22 is a substrate; 23 is a polarizing layer; 3 is a liquid crystal cell; 4 is a polarizing plate; 41 is a substrate; 42 is a substrate; 43 is a substrate; and 5 is a backlight unit.

### DESCRIPTION OF THE PREFERRED EMBODIMENTS

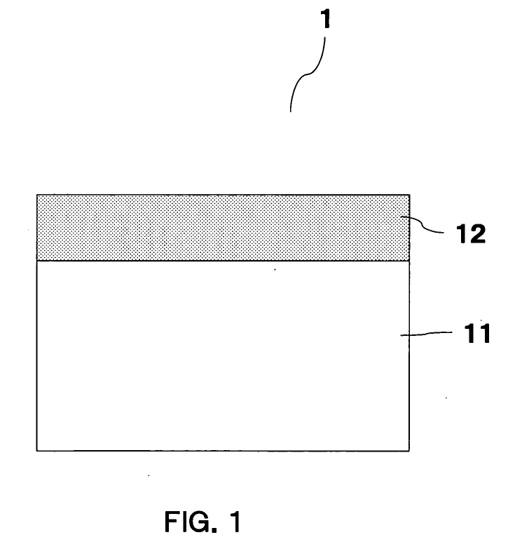

FIG. 1 is an exemplary cross-sectional diagram showing an embodiment of a hard coat film of the present invention. The hard coat film of the present invention has a hard coat layer (12) on a cellulose ester substrate (11). In this case, the hard coat layer (12) is formed by curing an ionizing radiation-curable material with ionizing radiation.

The inventor of the present invention studied a method for improving the hardness of the hard coat layer on the cellulose ester substrate. In this study, it was found that the following processes could improve the hardness of the hard coat layer of the hard coat film: a step of applying a coating material, including an ionizing radiation-curable material dissolved or dispersed in a solvent, to a cellulose ester substrate; a step of drying the coating material applied to the cellulose ester substrate; a step of curing and forming a hard coat layer by irradiating the coating material with ionizing radiation; and thereafter a step of baking the cellulose ester substrate with the hard coat layer.

It is necessary to consider the influence of water on a substrate in order to provide a hard coat layer with sufficient pencil sharpness. That is, the cellulose ester substrate easily absorbs water. Thereby, the hardness of the substrate is reduced. The hardness of the substrate greatly influences the pencil hardness. Therefore, it is necessary to remove this influence.

Therefore, the inventor of the present invention found that the step of baking after the step of curing the hard coat layer can allow the pencil sharpness to be improved. That is, processes of forming a hard coat layer usually finish after the applying step, the drying step and the curing step. However, the step of baking after the step of curing can allow water included in the substrate to be reduced. Thereby, the substrate is hardened while the pencil sharpness as a hard coat film can be improved. That is, the inventor of the present invention found that the influence of the substrate on the pencil sharpness was reduced as much as possible and the pencil sharpness as a hard coat film was improved.

In addition, the additional step of baking after the step of curing the hard coat layer can remove a residual solvent included in the coating material which exists inside the hard coat layer and in an interface between the hard coat layer and the cellulose ester substrate. The hardness of the hard coat layer, by itself, can be increased.

It is desirable that the heating (baking) condition in the heating (baking) step after the curing step be 40° C.-150° C. for 1 minute-120 hours. More preferably, it is 24-120 hours at 40-69° C. and 1-10 minutes at 70-150° C.

If the condition is short heating time at a low heating temperature, hardness is not improved. Further, if the condition is long heating time at a high heating temperature, the cellulose ester substrate becomes deformed. In the case where the heating temperature is more than 150° C., even if the heating time is short, the cellulose ester substrate may become deformed. In addition, in the case where the heating temperature is less than 40° C., the effect of the present invention is not obtained.

In addition, in the present invention, it is desirable that the coating material for forming the hard coat layer includes a solvent which does not dissolve the cellulose ester substrate of 50% or more based on the total solvents included in the coating material.

The solvents included in the coating material are divided between a solvent which does not dissolve the cellulose ester substrate and a solvent which does dissolve the cellulose ester substrate. Here, in the case where a solvent dissolves the cellulose substrate of more than 50% is used, a film thickness of an intermediate layer becomes large, wherein the cellulose substrate component and the hard coat layer component are mixed in the intermediate layer. Thereby, the surface hardness of the obtained hard coat film may be reduced.

In addition, in the present invention, it is desirable that the film thickness of the cellulose ester substrate be 30-90 μm. In the case where the film thickness of the cellulose ester substrate is less than 30 μm, the handling of the hard coat film to be formed is difficult. Therefore, there may be a case in which attaching the hard coat film to other elements fails. In addition, in the case where the film thickness of the cellulose ester substrate is more than 90 μm, the handling of the hard coat film to be formed is also difficult. Therefore, there may be a case in which attaching the hard coat film to other elements fails. When a hard coat film of the present invention is used for an element of a liquid crystal display, a polarizing plate is made using the hard coat film. At this time, if the film thickness of the cellulose ester substrate is more than 90 μm, some failures may occur.

A thickness of the hard coat layer of this invention may preferably be 3 μm or more to 15 μm or less. In the case where the thickness of the hard coat layer is less than 3 μm, a satisfactory surface hardness of the hard coat layer is not achieved in some cases. When the thickness of the hard coat layer exceeds 15 μm, a degree of curling of the hard coat film on which the hard coat layer is formed becomes too large. When the degree of curling is too large, it is difficult to attach the hard coat film to another element.

A method for manufacturing a hard coat film of the present invention is further described in detail.

Examples of cellulose ester substrates used for the present invention include a cellulose diacetate film, a cellulose triacetate film, a cellulose acetate butyrate film and a cellulose acetate propionate film. Among them, the cellulose triacetate film is used since the cellulose triacetate film is physically, optically and thermally preferred.

It is desirable that the cellulose ester substrate includes a plasticizer. The kinds of the plasticizers are not especially limited. However, examples of the plasticizers include a phosphate ester system plasticizer, a phthalate ester plasticizer, a trimellitate system plasticizer, a pyromellitic acid system plasticizer, a glycolate system plasticizer, a citrate plasticizer and a polyester plasticizer

Examples of the phosphate ester system plasticizers include triphenyl phosphate, tricresyl phosphate, cresyl diphenyl phosphate, octyl diphenyl phosphate, diphenyl biphenyl phosphate, trioctyl phosphate and tributyl phosphate. The examples of the phthalate ester plasticizers include diethyl phthalate, dimethoxy ethyl phthalate, dioctyl phthalate, dibutyl phthalate, di-2-ethylhexyl phthalate, butyl benzyl phthalate and cyclohexyl phthalate. The pyromellitic acid system plasticizers include tetrabuthyl pyromellitate, tetraphenyl pyromellitate and tetraethyl pyromellitate. The examples of glycolate system plasticizers include ethyl phthalyl ethyl glycolate, methyl phthalyl ethyl glycolate and butyl phthalyl butyl glycolate.

It is desirable that the plasticizer may be used alone or a plurality of the plasticizers may be simultaneously used. In addition, the additive amount of the plasticizer may be 1-30 weight % based on cellulose ester, in view of film performance and film manufacturing.

It is desirable that the cellulose ester substrate of the present invention includes an ultraviolet absorber in view of ultraviolet degradation in an application for outdoor use. An ultraviolet absorber which is superior in absorbing an ultraviolet ray having a wavelength of 370 nm or less and does not absorb much visible light having a wave length of 400 nm or more is preferred.

Examples of such an ultraviolet absorber include an oxy-benzophenone system compound, a benzotriazole system compound, a salicylate ester system compound, a benzophenone system compound, a cyanoacrylate compound, a nickel complex salt system compound and a triazine-type compound.

Examples of the benzotriazole system ultraviolet absorber include 2-(2′-hydroxy-5′-methylphenyl)benzotriazole and 2-(2′-hydroxy-3′, 5′-di-tert-butylphenyl)benzotriazole. Examples of the commercial items include TINUVIN109, TINUVIN171 and TINUVIN 326 (products of Chiba Specialty Chemicals Ltd)

Examples of benzophenone system ultraviolet ray absorbers include 2,4-dihydroxybenzophenone, 2,2′-dihydroxy-4-methoxy benzophenone and 2-hydroxy-4-methoxy-5-sulfo benzophenone.

The cellulose ester film used for the substrate for the present invention is a film manufactured by the following steps: a step of preparing a dope by dissolving a cellulose ester and additives in a solvent; a step of casting the dope on a metal support body; a step of expanding or contracting the dope or a step of maintaining a width of the dope; further a step of drying the dope; and a step of winding up the dried dope. It is desirable that the thickness of the film be 30-90 μm.

In the present invention, a hard coat layer is formed using a coating material in which an ionizing radiation-curable material is dissolved or dispersed in a solvent. In the present invention, an ionizing radiation-curable material means a material of which the main component is cured through a crosslinking reaction by irradiating with an ionizing radiation such as an ultraviolet ray or electron beam.

A photopolymerizability monomer or a photopolymerizability prepolymer can be used for the ionizint radiation-curable material for the present invention. Among them, (meth) acrylate monomer or oligomer having a (meth) acrylyl oxy group is preferred.

Examples of (meth) acrylate monomer having a (meth) acrylyl oxy group are as follows: 1,4-butanediol di (meth) acrylate; 1,6-hexanediol di (meth) acrylate; neopentyl glycol (meth) acrylate; ethylene glycol di (meth) acrylate; triethylene glycol di (meth) acrylate; tripropylene glycol di (meth) acrylate; dipropylene glycol di (meth) acrylate; 3-MPD [2-methyl-2,4-pentanediol] di(meth) acrylate; diethylene glycol bis β-(meth) acrylyl oxy-propionate; methyltrimethylolmethane tri(meth) acrylate; trimethylolpropane tri (meth) acrylate; pentaerythritol tri (meth) acrylate; pentaerythritol triacrylate; dipentaerythritol hexa (meth) acrylate; tri (2-hydroxyethyl) isocyanate di (meth) acrylate; pentaerythritol tetra (meth) acrylate; 2,3-bis (meth) acrylyl oxy-ethyloxymethyl [2.2.1]heptane; poly 1,2-butadiene di (meth) acrylate; 1,2-bis (meth) acrylyl oxy-methylhexane; nona ethylene glycol di (meth) acrylate; tetradecane ethylene glycol di (meth) acrylate; 10-decane diol (meth) acrylate; 3,8-bis(meth) acrylyl oxymethyl tricyclo decane; hydrogenation bispenol A di (meth) acrylate; 2,2-bis (4-(meth) acrylyl oxy-diethoxy phenyl) propane; 1,4-bis ((meth) acrylyl oxymethyl) cyclohexane; hydroxy pivalic acid ester neopentyl glycol di (meth) acrylate; bispenol A diglycidyl ether di (meth) acrylate; epoxy denatured bispenol A di (meth) acrylate. The above-mentioned (meth) acrylate can be used alone or two or more kinds of these (meth) acrylates can be used together. In addition, in these coating materials, the component may be a monomer or an oligomer in which monomers are partially polymerized.

It is desirable that a (meth) acrylate monomer having 3 or more (meth) acrylyl oxy groups be used for the (meth) acrylate monomer having the (meth) acrylyl oxy group used for the ionizing radiation-curable material. The (meth) acrylate monomer having 3 or more (meth) acrylyl oxy groups can allow the hard coat layer to have high pencil sharpness.

In addition, polyfunctional urethane (meth) acrylate among (meth) acrylate monomers is preferably used because, in polyfunctional urethane (meth) acrylate, the molecular weight and the molecular structure thereof can be designed and the characteristics of the hard coat layer can be easily balanced. In particular, UA-306H, UA-306T and UA-3061 (products of KYOEISHA CHEMICAL Co., LTD.), UV-1700B, UV-6300B, UV-7600B, UV-7605B, UV-7640B and UV-7650B (products of Nippon Synthetic Chemical Industry Co., LTD.), U-4HA, U-6HA, UA-100H, U-6LPA, U-15HA, UA-32P and U-324A (products of Shin-nakamura Chemical Co., LTD.), Ebecryl-1290, Ebecryl-1290K and Ebecryl-5129 (DAICEL-UCB Company LTD.), UN-3220HA, UN-3220HB, UN-3220HC and UN-3220HS (products of Negami Chemical Industrial Co., Ltd.) can be used, but usable products are not limited to these.

In addition, polyester acrylate obtained by esterifying polybasic acid, polyalcohol and acrylic acid can be used.

In addition, an acrylate obtained by the following process can be used: an epoxy resin is reacted with a carboxylic acid having an acrylic acid. The acrylate may be an epoxy acrylate using aromatic ring or alicyclic epoxy.

It is desirable that a solvent which does not dissolve the cellulose ester substrate of 50% or more based on total solvents in the coating material be included in the coating material used for the present invention.

Examples of solvents which do not dissolve a cellulose triacetate substrate among cellulose ester substrates include some ketones such as methyl isobutyl ketone and cyclohexanone, aromatic hydrocarbons such as toluene and xylene, alcohols such as 2-propanol, 1-butanol, cyclopentanol and diacetone alcohol, ether alcohols such as ethylene glycol monomethyl ether and propylene glycol methyl ether, and some esters such as isobutyl acetate and butyl acetate.

Among them, ketones having a high boiling point, aromatic hydrocarbons, alcohols and ester acetate having a high boiling point are preferred for solvents which do not dissolve a cellulose triacetate substrate. Especially, methyl isobutyl ketone, toluene and 2-propanol are preferred.

In addition, a solvent which dissolves cellulose ester substrate of 50% or less based on total solvents in the coating material can be used for a solvent in the coating material. The use of the solvent which dissolves the substrate can allow the occurrence of the interference pattern of the hard coat film to be controlled. In addition to this, the use of the solvent can improve the adhering property between the hard coat layer and the cellulose ester substrate. This is because an intermediate layer is formed at an interface between the hard coat layer and the cellulose ester substrate, wherein the solvent which dissolves the cellulose ester substrate dissolves the cellulose ester substrate, thereby the hard coat component and the cellulose ester component are mixed in the intermediate layer.

However, in the case where the solvent which dissolves the cellulose ester substrate of more than 50% based on total content of all solvents is used, the film thickness of the intermediate layer where the hard coat layer component and the cellulose ester component are mixed becomes too large. Thereby, the pencil sharpness of the obtained hard coat film tends to be reduced.

As a solvent which dissolves a cellulose triacetate film, ether such as dibutyl ether, dimethoxymethane, dimethoxyethane, diethoxyethane, propylene oxide, dioxan, dioxolane, trioxane, tetrahydrofuran, anisole and phenetole, or some ketones such as acetone, methyl ethyl ketone, diethyl ketone, dipropyl ketone, di-isobutyl ketone, cyclopentanone, cyclohexanone, methylcyclohexanone and methylcyclohexanone, or some esters such as ethyl formate, propyl formate, formic acid n-pentyl, methyl acetate, ethyl acetate, methyl propionate, ethyl propanoate, acetic acid n-pentyl and γ-butyrolactone, or Cellosolve such as methyl cellosolve, cellosolve, butylcellosolve and Cellosolve acetate can be used.

A photopolymerization initiator and a photosensitizing agent can be added to the coating material used for the present invention.

Examples of photopolymerization initiators include acetophenone, benzoin, benzophenone, phosphine oxide, ketal, anthra quinines and thioxanthone. Examples, in detail, include 2,2-ethoxyacetophenone, 1-hydroxycyclohexylphenylketone, dibenzoyl, benzoin, benzoinmethylether, benzomethylether, p-chlorobenzophenone, p-methoxybenzophenone, Michler's ketone, acetophenone, 2-chlorothioxanthone.

N-butylamine, triethylamine, poly-n-butylphosphine or the like, or a mixed material thereof can be used for a photosensitizing agent

A particle can be added to the coating material used for the present invention. A particle can be used for the purpose of adjusting a refractive index of the hard coat layer. In addition, a particle can be also used for the purpose of increasing the hardness of the hard coat layer, by itself. In addition, a particle can be also used for the purpose of providing the front surface of the hard coat layer with a rugged structure in order to provide the front surface of the hard coat layer with an antiglare property. In addition, a conductive particle can be used for the purpose of providing the hard coat layer with an antistatic property.

A hard coat film of the present invention can be a clear type hard coat film having a low haze value and can be an antiglare type hard coat film having a high haze value.

Inorganic particles among usable particles are oxide particles such as oxidation silicon, titanium oxide, aluminium oxide, zirconia, magnesium oxide, tin oxide, antimony pentaoxide, complex oxides such as antimony doped tin oxide and phosphor doped tin oxide, calcium carbonate, talc, cray, kaolin, calcium silicate, aluminium silicate, magnesium silicate, calcium phosphate.

As organic particles, a poly methacryl system methyl acrylate particle, an acryl-styrene system particle, a polymethyl methacrylate resin particle, a silicon resin particle, a polystyrene system particle, a polycarbonate particle, a melamine system resin particle and a polyolefin resin particle can be used.

It is desirable that an average particle diameter of these particle be 5 nm-20 μm. A more preferable range is 10 nm-10 μm. In addition, these fine particles can be used as an embodiment in which two or more kinds of particle are used. In addition, in the case where a particle having a particle diameter of a wavelength of the visible light or less is used, the haze value is not increased and the total light transmittance is not lowered while the particle can provide the hard coat layer with an additional function.

In addition, additives can be added to the coating material for the present invention in order to improve antifouling properties, slip properties, defect preventing properties and particle dispersion properties. Examples of the additives include polyether denatured polymethyl alkylsiloxane, polyether denatured DMPS [dimethylpolysiloxane], fluorine denatured polymer, acrylic polymer, polyester denatured acryl contained DMPS [dimethylpolysiloxane] and silicon denatured poly acryl.

In the coating material used for the present invention, it is desirable that the content of the solid component including the ionizing radiation-curable material and the photopolymerization initiator be 30-80 weight %. In the case where the content of the solid component in the coating material is less than 30%, the hard coat layer having a desirable film thickness can not be obtained. On the other hand, in the case where the content of the solid component is more than 80%, the viscosity of the coating material becomes high. Thereby, unevenness in the surface of the hard coat layer may easily occur.

The coating material obtained in this way is applied to the cellulose ester substrate (the step of applying). Examples of the application methods include bar coating, dip coating, spin coating, flow coating, spray coating, roll coating, gravure roll coating, air doctor coating, blade coating, wire doctor coating, knife coating, reverse coating, transfer roll coating, micro-gravure coating, kiss coating, cast coating, slot orifice coating, calendar coating and die coating.

Next, the coating material applied to the cellulose ester substrate is dried for the purpose of removing the solvent (the step of drying). The drying is performed by heating, sending air, heated air or the like. For example, in the case where a hard coat film is manufactured by the roll-to-roll method, a solvent can be removed by sending the cellulose ester substrate including a coated film through a drying stove or an oven after the step of applying has finished.

Next, the hard coat layer is formed by curing the applied and dried coating material on the cellulose ester substrate by irradiating the material with an ionizing radiation (the step of curing). As an ionizing radiation, an ultraviolet ray or electron beam can be used. As a light source emitting an ultraviolet ray, a low-pressure mercury lamp, a medium pressure mercury-vapor lamp, a high pressure mercury vapor lamp, a carbon-arc lamp, a metal halide lamp, a xenon lamp, an electrodeless discharge tube or the like can be used. It is desirable that the amount of the ultraviolet ray irradiation be usually within a range of 100 to 800 mJ/cm². In the case of the electron ray curing, an electron ray emitted from various electron ray accelerators such as a Cockroft-Walton accelerator, a Van de Graaff accelerator, a resonance transformer accelerator, an insulated core transformer accelerator, a linear accelerator, a dynamitoron accelerator, a high frequency accelerator, and the like may be used. The electron ray may preferably have energy of 50 to 1,000 KeV. The electron ray having energy of 100 to 300 Kev is more preferable.

In addition, in the case where the hard coat layer is formed on the cellulose ester substrate, the following steps are performed: the step of applying the coating material to the cellulose ester substrate; the step of drying the coating material applied to the cellulose ester substrate; and the step of curing the coating material by irradiating the coating material on the cellulose ester substrate with an ionizing radiation. The above-mentioned steps are continuously performed by the following processes: a wound up cellulose ester substrate is continuously sent so that the substrate passes through an applying unit, a drying unit and a unit irradiating an ionizing radiation, in this order; and thereafter the substrate is wound up.

Next, the cellulose substrate having the hard coat layer is baked (the step of baking). The baking can be, for example, performed by an oven. The baking can be performed by storing the cellulose substrate having the hard coat layer in an oven or the like. In the case where the hard coat film is manufactured by the roll-to-roll method, the baking can be performed by the following processes: irradiation with the ionizing radiation is performed; thereafter the cellulose ester substrate having the hard coat layer is wound up; and the cellulose substrate is stored in an oven of 40° C. or more in a state where the substrate is wound up.

In addition, in the case where the hard coat layer on a cellulose ester substrate bends due to shrinkage or curing, if the baking of a certain type is performed so that the bending becomes flat, it is expected that the degree of the bending is reduced.

The hard coat film manufactured in this invention is, as needed, provided with a function layer on the hard coat layer. As the function layer, those having an anti-reflection property, an antistatic property, an anti-fouling property, anti-glare property, an electromagnetic wave-shielding property, an infrared ray absorption property, an ultraviolet ray absorption property, a color correction property, and the like may be used. Examples of such function layers include an anti-reflection layer, an antistatic layer, an anti-fouling layer, an anti-glare layer, an electromagnetic wave-shielding layer, an infrared ray absorption layer, an ultraviolet ray absorption layer, a color correction layer, and the like. The function layer may be a single layer or may be formed of a plurality of layers. For example, the anti-reflection layer may be formed of a single low refractive index layer or may be formed of plural layers of a low refractive index layer and a high refractive index layer that are alternately laminated. Also, the single function layer may have a plurality of functions such as an anti-reflection layer having anti-fouling properties.

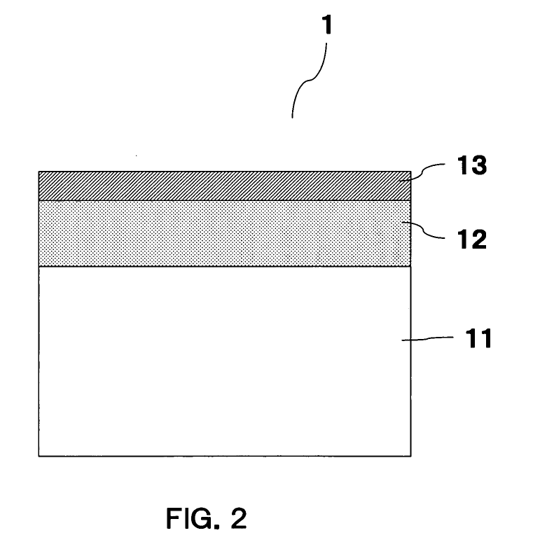

FIG. 2 is a schematic cross-sectional diagram showing another embodiment of a hard coat film of the present invention. The hard coat film of the present invention has a hard coat layer (12) and a low refractive index layer (13) which is a reflection preventing layer, over a cellulose ester substrate (11).

Examples of the low refractive index layer which is a reflection preventing layer include a member in which a low refractive index agent is dispersed in a binder matrix. In this case, the low refractive index agent is not limited especially. Examples of the low refractive index agents include a magnesium fluoride, a particle containing air and a fluorine resin. The coating material is prepared by dispersing the low refractive index agent in a binder matrix material such as an ionizing radiation-curable material or a metalalkoxide such as a silicon alkoxide. A solvent is added to the coating material as needed. Then the coating material is applied to the hard coat layer of the hard coat film. Thereafter, in the case where an ionizing radiation-curable material is used for the binder matrix material, the low refractive index layer can be formed by irradiating with an ionizing radiation. In the case where a metalalkoxide is used as the binder matrix material, the low refractive index layer can be formed by burning. In addition, the above-mentioned photopolymerizability monomer or photopolymerizability prepolymer can be used for the ionizing radiation-curable material. In addition, silicon alkoxides such as tetramethoxy silane or tetraethoxysilane can be used as the metalalkixide.

As a coating method, bar coating, dip coating, spin coating, flow coating, spray coating, roll coating, gravure roll coating, air doctor coating, blade coating, wire doctor coating, knife coating, reverse coating, transfer roll coating, micro-gravure coating, kiss coating, cast coating, slot orifice coating, calendar coating, die coating, or the like may be employed.

In view of cost, as the reflection preventing layer, a single layer comprised of a low refractive index layer is preferred more than a plurality of layers in which a low refractive index layer and a high refractive index layer are repeatedly laminated. In this case, a film thickness (d) of the single layer comprised of the low refractive index layer is designed so that the optical thickness (nd) obtained by multiplying the film thickness (d) by the refractive index (n) of the low refractive index layer is equal to ¼ of the wavelength of the visible light.

On the other hand, it is desirable that the plurality of layers in which a low refractive index layer and a high refractive index layer are repeatedly laminated be used for the reflection preventing layer in order to obtain a high reflection preventing performance. In this case, for example, a reflection preventing layer of four layers structure is obtained by the following processes: titanium oxide as a high refractive index layer, silicon oxide as a low refractive index layer, titanium oxide as a high refractive index layer and silicon oxide as a low refractive index layer are, in this order, formed on a hard coat layer by a vacuum evaporation method.

In addition, before forming a low refractive index layer, a saponifying treatment using an alkali solution can be performed for the hard coat layer of the hard coat film for the purpose of improving the adhesion property between the hard coat layer and the reflection preventing layer.

The hard coat film of this invention is, to be provided on a surface of a display such as a liquid crystal display (LCD), a CRT display, an organic electroluminescence display (ELD), a plasma display (PDP), a surface-conduction electron-emitter display (SED), and a field emission display (FED) for the purpose of protecting the display surface.

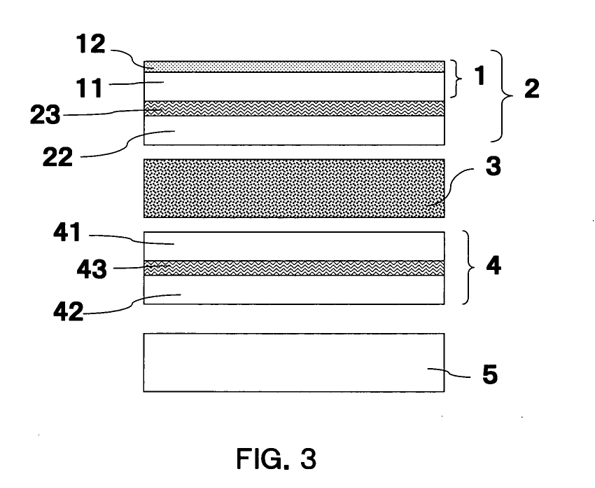

FIG. 3 is a schematic sectional view showing a transmissive liquid crystal display on whose surface the hard coat film of this invention is provided. A transmissive liquid crystal display of FIG. 3 is provided with a backlight unit (5), a polarization plate (4), a liquid crystal cell (3), a polarization plate (2) including a hard coat film (1) in this order. The hard coat layer (12) side of the hard coat film (1) is the side to be viewed, i.e. the display surface.

A backlight unit (5) comprises a light source and a light diffusing plate. As for a liquid crystal cell, a TFT electrode is provided on a substrate in one side, an electrode and a color filter are provided on a substrate in another side and a liquid crystal is encapsulated between both of the electrodes. As for polarization plates sandwiching a liquid crystal cell (3), polarization layers (23, 43) are between substrates (11, 22, 41 and 42).

In FIG. 3, a polarizing layer (23) is provided on a surface of a cellulose ester substrate (11) of a hard coat film (1), wherein a hard coat layer is provided on another surface of the cellulose ester substrate (11). The cellulose ester substrate (11) is a substrate of both the hard coat film (1) and a polarizing plate (2). That is, the hard coat film (1) is part of the polarizing plate (2). In this case, polyvinyl alcohol film stained with iodine can be used for a polarizing layer (23). In addition, a cellulose ester substrate can be used for another substrate (22).

In addition, a transmission type liquid crystal display of the present invention can have other functional elements. Examples of other functional elements include a diffusing film, a prism sheet and a luminance improving film for using light emitted from a backlight effectively, and a phase difference film for compensating a phase difference of a liquid crystal cell or a polarizing plate.

The manufacturing method of the present invention can allow a hard coat film including a hard coat layer having a sufficient pencil sharpness and a cellulose ester substrate to be manufactured.

### EXAMPLE

Hereinafter, the present invention is described with reference to Examples.

In addition, the performances of the manufactured hard coat films were evaluated by the following method:

<Haze>

The haze of the obtained hard coat films was measured according to JIS-K7105 using NDH-200 (a product of Nippon Denshoku Industries Co., Ltd.);

<Total Light Transmittance>

The total light transmittance of the obtained hard coat films was measured according to JIS-K7105 using NDH-200 (a product of Nippon Denshoku Industries Co., Ltd.);

<Pencil Sharpness>

The pencil sharpness of surfaces of the hard coat layers of the obtained hard coat films was evaluated according to JIS-K5400; and

<Abrasion Resistant Property>

A surface of the hard coat layer of the obtained hard coat films were scrubbed by a steel wool (#0000) wherein the steel wool was reciprocated 10 times and the steel wool was under 250 g/cm² load. It was observed whether scratches occurred or not.

### Example 1

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

methylisobutylketone 50 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 92.0%, haze thereof was 0.20%. In the abrasion resistant test, there was no scratch. The pencil hardness was 5H.

### Example 2

A cellulose triacetate substrate having a thickness of 80 μm was used.

A coating liquid was prepared by agitating and mixing the following materials:

urethane acrylate 1700 B (a product of Nippon synthetic chemical industry Co., LTD) 50 parts by weight;

Irgacure 184 (a product of Ciba Specialty Chemicals) 2.5 parts by weight;

Toluene 50 parts by weight;

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 91.5%, haze thereof was 0.20%. In the abrasion resistant test, there was no scratch. The pencil hardness was 5H.

### Example 3

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

isopropanol 50 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 92.0%, haze thereof was 0.20%. In the abrasion resistant test, there was no scratch. The pencil hardness was 5H.

### Example 4

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 24 parts by weight;

acrylic monomer PE-3A (a product of KYOEISHA CHEMICAL Co., LTD) 12 parts by weight;

silica fine particle IPA-ST (a product of NISSAN chemical industries, LTD. A content of solid component was 30%.) 30 parts by weight;

Irgacure 184 (a product of Ciba Specialty Chemicals) 2.25 parts by weight; and

isopropanol 24 parts by weight.

This coating liquid was applied to the substrate by a bar coating method and was dried so that the thickness of the hardened film was 14 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 91.5%, haze thereof was 0.15%. In the abrasion resistant test, there was no scratch. The pencil hardness was 5H.

### Example 5

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

methylisobutylketone 40 parts by weight;

methylethylketone 10 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 91.5%, haze thereof was 0.20%. In the abrasion resistant test, there was no scratch. The pencil hardness was 5H.

### Example 6

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

methylethylketone 50 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 40° C. for 100 hours to obtain a hard coat film. The total light transmittance of this hard coat film was 92.0%, haze thereof was 0.20%. In the abrasion resistant test, there was no scratch. The pencil hardness was 3H.

### Example 7

A cellulose triacetate substrate having a thickness of 80 μm was used.

A coating liquid was prepared by agitating and mixing the following materials:

urethane acrylate 1700B (a product of Nippon synthetic chemical industry Co., LTD) 50 parts by weight;

Irgacure 184 (a product of Ciba Specialty Chemicals) 2.5 parts by weight;

methyl acetate 25 parts by weight;

methylisobutylketone 25 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp. Thereafter, the hard coat layer was heated at 100° C. for 3 minutes to obtain a hard coat film. The total light transmittance of this hard coat film was 91.5%, haze thereof was 0.20%. In the abrasion resistant test, there was no scratch. The pencil hardness was 4H.

### Comparative Example 1

A cellulose triacetate substrate having a thickness of 80 μm was used.

A coating liquid was prepared by agitating and mixing the following materials:

urethane acrylate 1700B (a product of Nippon synthetic chemical industry Co., LTD) 50 parts by weight;

Irgacure 184 (a product of Ciba Specialty Chemicals) 2.5 parts by weight;

methyl acetate 50 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp to obtain a hard coat film. Heating of the hard coat layer was not performed. The total light transmittance of this hard coat film was 91.5%, haze thereof was 0.20%. In the abrasion resistant test, there was no scratch. The pencil hardness was 2H.

### Comparative Example 2

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

methylisobutylketone 40 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp to obtain a hard coat film. Heating of the hard coat layer was not performed. The total light transmittance of this hard coat film was 91.0%, haze thereof was 0.20%. In the abrasion resistant test, there was no scratch. The pencil hardness was 2H.

### Comparative Example 3

A cellulose triacetate substrate having a thickness of 80 μm was used.

A coating liquid was prepared by agitating and mixing the following materials:

urethane acrylate UA-306H (a product of KYOEISHA CHEMICAL Co., LTD) 30 parts by weight;

acrylic monomer PE-3A (a product of KYOEISHA CHEMICAL Co., LTD) 20 parts by weight;

Irgacure 184 (a product of Ciba Specialty Chemicals) 2.5 parts by weight;

methylethylketone 50 parts by weight; and

BYK-307 (a product of BYK-Chemie) 0.15 parts by weight.

This coating liquid was applied to the substrate by a bar coating method and was dried so that the thickness of the hardened film was 12 μm. Thereafter, a hard coat layer was formed by irradiating the hardened film with an ultra violet ray of 400 mJ by a metal halide lamp to obtain a hard coat film. Heating of the hard coat layer was not performed. The total light transmittance of this hard coat film was 91.5%, haze thereof was 0.15%. In the abrasion resistant test, there was no scratch. The pencil hardness was 2H.

Evaluation results of the hard coat films obtained in Examples 1 to 7 and Comparative Examples 1 to 3 are shown in Table 1.

TABLE 1

| | | | | total light |
|---|---|---|---|---|
| | | abrasion | | transmittance |
| | pencil hardness | resistant test | Haze (%) | (%) |
| Example 1 | 5H | no scratch | 0.20 | 92.0 |
| Example 2 | 5H | no scratch | 0.20 | 91.5 |
| Example 3 | 5H | no scratch | 0.20 | 92.0 |
| Example 4 | 5H | no scratch | 0.15 | 91.5 |
| Example 5 | 5H | no scratch | 0.20 | 91.5 |
| Example 6 | 3H | no scratch | 0.20 | 92.0 |
| Example 7 | 4H | no scratch | 0.20 | 91.5 |
| Comparative | 2H | no scratch | 0.20 | 91.5 |
| Example 1 | | | | |
| Comparative | 2H | no scratch | 0.20 | 91.0 |
| Example 2 | | | | |
| Comparative | 2H | no scratch | 0.15 | 91.5 |
| Example 3 | | | | |

What is claimed is:

1. A method for manufacturing a hard coat film having a cellulose ester substrate and a hard coat layer on said cellulose ester substrate, comprising:
applying a coating material including an ionizing radiation-curable material dissolved or dispersed in a solvent to said cellulose ester substrate;
drying said coating material which is applied to said cellulose ester substrate;
forming a hard coat layer by curing said coating material by irradiating said coating material with an ionizing radiation; and
baking said cellulose ester substrate having said hard coat layer.

2. The method for manufacturing the hard coat film according to claim 1, wherein a condition of said baking is 40-150° C. and 1 minute-120 hours.

3. The method for manufacturing the hard coat film according to claim 1, wherein said coating material includes a solvent which does not dissolve said cellulose ester substrate, wherein said solvent comprises at lease 50% of the total solvent mixture.

4. The method for manufacturing the hard coat film according to claim 1, wherein a film thickness of said cellulose ester substrate is 30-90 μm.

5. The method for manufacturing the hard coat film according to claim 1, wherein a film thickness of said hard coat layer is 3-20 μm.

6. A method for manufacturing a hard coat film having a cellulose ester substrate and a hard coat layer on said cellulose ester substrate, comprising:
applying a coating material including an ionizing radiation-curable material dissolved or dispersed in a solvent to said cellulose ester substrate;
drying said coating material which is applied to said cellulose ester substrate after applying said coating material;
forming a hard coat layer by curing said coating material by irradiating said coating material with an ionizing radiation after drying said coating material; and
baking said cellulose ester substrate having said hard coat layer after forming said hard coat layer.
